(19) United States
(12) Patent Application Publication
(10) Pub. No.: US 2006/0061861 A1
(43) Pub. Date: Mar. 23, 2006

(54) High performance rear-projection screen

(75) Inventors: James F. Munro, Ontario, NY (US); Patrick W. Mullen, Barkhamsted, CT (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Reflexite Corporation, Avon, CT (US)

(21) Appl. No.: 10/948,094

(22) Filed: Sep. 23, 2004

(51) Int. Cl. G03B 21/60

(52) U.S. Cl. 359/456

(57) ABSTRACT

A rear-projection screen and a method for forming same are provided. The screen can include a substrate including a first side and a second side, apertures disposed on the first side of the substrate, and an opaque layer disposed on the second side of the substrate. In a particular embodiment, the opaque layer includes a plurality of apertures therethrough. A surface relief diffuser can be provided in the substrate at the plurality of apertures. A bulk diffuser can be provided at the plurality of apertures to diffuse the projected image. A cover can be attached to the opaque layer, for example, with an adhesive. An overlayer can be provided on the opaque layer for providing deep apertures that can be filled with bulk diffuser to further diffuse the projected image. The overlayer disposed on the opaque layer can include a light-absorbing material in and/or on the overlayer.

### BACKGROUND OF THE INVENTION

Rear-projection screens are utilized in various types of equipment, such as projection-based radar displays, televisions, flight simulators, avionic displays, traffic control lights, microfilm readers, video games, projection-based video monitors, and rear-projection film media displays for generating a user-viewable display. In such applications, an image source located behind the screen projects light forward along a projection axis toward the screen to form an image at the plane of the screen which is distributed to viewers on the front side of the screen.

Where multiple viewers are present, such viewers are typically positioned horizontally, and distribution of light through a large horizontal angle is desirable. This is particularly true in rear-projection televisions, where multiple viewers are generally present and seated throughout a relatively wide horizontal angle relative to the screen. Since the viewers are not generally spread in the vertical direction, the screen therefore restricts the angular distribution of the light in the vertical direction.

An ideal rear projection screen is also one that transmits as much of the projected light as possible, with typical transmissions exceeding eighty percent or even ninety percent. At the same time the screen should also absorb as much ambient light incident upon it from the front side, in order to increase the black level, and the contrast, of the screen. Absorbing most of the front light, while at the same time maximizing the transmittance of the light projected onto the screen from the rear side, is challenging to the screen designer, but is necessary in order for the screen to be labeled a high-performance screen.

### SUMMARY OF THE INVENTION

A rear-projection screen is provided in accordance with one embodiment that includes a substrate including a first side and a second side, lenticular lenses or an array of microlenses disposed on the first side of the substrate, and an opaque layer disposed on the second side of the substrate. In a particular embodiment, the opaque layer includes a plurality of apertures therethrough. A surface relief diffuser can be provided in the substrate at the plurality of apertures to diffuse the projected image.

A bulk diffuser can be provided at the plurality of apertures to diffuse the projected image. A cover can be attached to the opaque layer, for example, with an adhesive. In a particular embodiment, the surface relief diffuser is formed by a laser ablation process, i.e., irradiation through and focused by the lenticulars ablates the opaque layer to form the plurality of apertures or grooves. At the same time, as part of the ablation process, the surface relief diffuser is formed in the surface of the substrate at the apertures. In one embodiment, the lenticular or microlenses including the microlens array are elliptical or circular in cross-section.

A method for forming a rear-projection screen is provided that includes forming lenticulars, or alternately a microlens array, on a first side of a substrate, forming an opaque layer on a second side of the substrate, and irradiating the lenticulars to form a plurality of apertures in the opaque layer and a surface relief diffuser in the substrate at the apertures. The method can also include providing a bulk diffuser in the plurality of apertures and attaching a cover to the opaque layer.

A rear-projection screen is provided that includes a substrate including a first side and a second side, lenticulars or a microlens array disposed on the first side of the substrate, and an opaque layer disposed on the second side of the substrate. An overlayer disposed on the opaque layer can include a plurality of apertures therethrough, and a bulk diffuser can be provided at the plurality of apertures.

A surface relief diffuser can be provided in the substrate at the plurality of apertures. A cover can be attached to the overlayer disposed on the opaque layer. The surface relief diffuser and the plurality of apertures are formed by a laser ablation process in one embodiment. The lenticulars or the lenslets including the microlens array can be elliptical or circular in cross-section.

The overlayer disposed on the opaque layer can include a light-absorbing material in and/or on the overlayer. In a particular embodiment, the light-absorbing material includes a color light-absorbing tint that can absorb blue light.

A method for forming a rear-projection screen is further provided that includes forming lenticulars or an array of microlenses on a first side of a substrate, forming an opaque layer on a second side of the substrate, forming an overlayer on the opaque layer, and irradiating the lenticulars to form a plurality of apertures in the opaque layer and the overlayer on the opaque layer. The step of irradiating the lenticulars can form a surface relief diffuser in the substrate at the plurality of apertures.

The method can further include providing a bulk diffuser in the plurality of apertures and attaching a cover to the overlayer. A light-absorbing material can be provided on and/or in the overlayer on the opaque layer. In a particular embodiment, the light-absorbing material includes a blue light-absorbing tint.

### BRIEF DESCRIPTION OF THE DRAWINGS

The foregoing and other objects, features and advantages of the invention will be apparent from the following more particular description of various embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a cross-sectional view of a rear-projection screen in accordance with an embodiment of the present invention.

FIG. 2 is a cross-sectional view of a rear-projection screen in accordance with another embodiment of the present invention.

FIG. 3 is an image taken by a scanning electron microscope (SEM) of a partial rear-projection screen.

FIG. 4 is a cross-sectional view of a rear-projection screen in accordance with a further embodiment of the present invention.

FIG. 5 is a view of the screen of FIG. 4 after a manufacturing step.

FIG. 6 is a view of the screen of FIG. 5 after a bulk diffuser has been provided in the apertures.

FIG. 7 is a cross-sectional view of a rear-projection screen in accordance with another embodiment of the present invention.

FIG. 8 is a cross-sectional view of a rear-projection screen in accordance with the prior art.

FIG. 9 is a cross-sectional view of a rear-projection screen in accordance with the present invention.

FIG. 10 is a front view of a rear-projection screen having a two-dimensional array of focusing elements on the rear-side, after a manufacturing step.

### DETAILED DESCRIPTION OF THE INVENTION

A description of various embodiments of the invention follows.

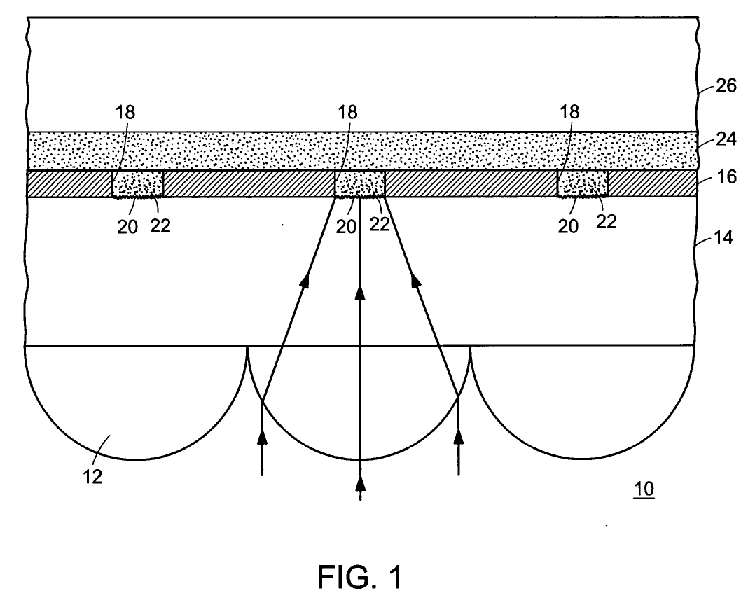

FIG. 1 is a cross-sectional view of an embodiment of a rear-projection screen 10 that has been constructed in accordance with principles of the present invention. Lenses 12, that can be for example, elliptical, circular, or circular-linear approximation-shaped, arranged in a one-dimensional lenticular array or two-dimensional array, are provided on a first side of a substrate 14. In one embodiment, the lenses 12 are cast on the substrate 14, which can have a thickness of about 0.15 mm. The substrate 14 should be substantially transparent and can include polyethylene terephthalate (PET), polycarbonate, or other suitable materials.

An opaque layer 16 is provided on the opposite or second side of the substrate 14. The opaque layer should be made as thin as possible, but not so thin that it becomes transmissive to light. In a particular embodiment, the opaque layer 16 has a thickness between about 10 to 30 micrometers. In a particular embodiment, opaque layer 16 is ablatable, that is, irradiation, such as a laser, can be directed through the lenses 12 to form apertures 18 in the opaque layer, as set forth in International Publications WO 00/67071, published on Nov. 9, 2000, WO 03/069407, published on Aug. 21, 2003, and WO 03/069408, published on Aug. 21, 2003, the entire teachings of each application being incorporated herein by reference. It has been discovered that by adjusting the intensity of the laser, a texture or surface relief diffuser (SRD) 20 is provided in the substrate 14 at the bottom of aperture 18. In a particular embodiment, the power of the laser is continuous and is in the range of about 20 to 2,000 watts. The SRD 20, which includes a shallow depth, diffuses light passing through the apertures 18. In one embodiment, the SRD 20 produces a light-diffusing optical element whose half-angles are about ±10 degrees, which is desirable for rear-projection television screens.

In further embodiments, the apertures 18 can be filled with a bulk diffuser 22 to further diffuse the light passing through the apertures. The bulk diffuser improves the grain and speckle characteristics while not sacrificing other screen performance parameters.

An adhesive layer 24 can be provided on the opaque layer 24 for attaching an outer layer or cover 26 thereto. The adhesive layer 24 can be substantially optically transparent. In a particular embodiment, the outer cover 26 has a thickness of about from about 2 mm to 3 mm and can include an acrylic material.

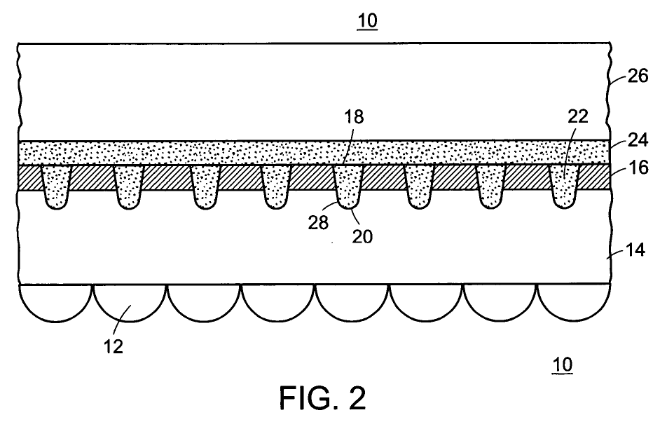

FIG. 2 is a cross-sectional view of a rear-projection screen 10 similar to the embodiment illustrated in FIG. 1. Depressions 28 caused by the laser ablation process extend deeper into the substrate 14, and thus the resulting SRD 20 is further from the lower plane of the opaque layer 16, and the bulk diffuser material 22 is thicker.

The screen 10 of FIGS. 1 and 2 can be produced with a high-throughput roll-to-roll manufacturing process using a minimum of optical layers, which yields a lower cost product whose performance ranks with the best on the market.

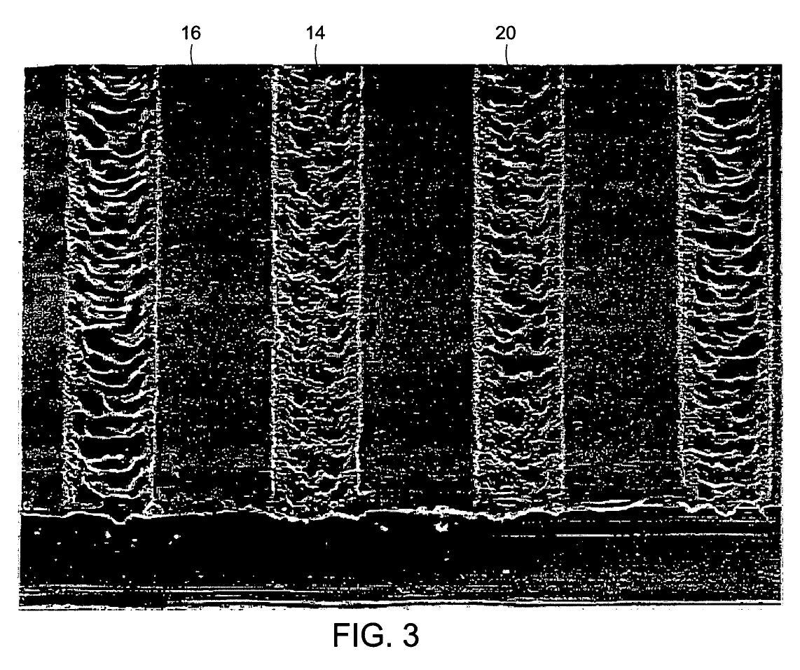

FIG. 3 is an image taken by a scanning electron microscope (SEM) of the SRD 20 formed in the substrate 14. Again, the SRD 20 produces an optical element whose half-angles are about ±10 degrees, which is desirable for rear-projection television screens.

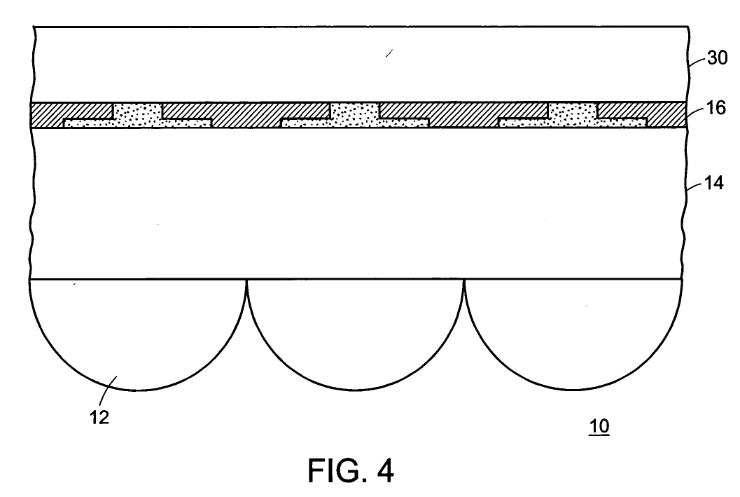

FIG. 4 is a cross-sectional view of a further embodiment of a rear-projection screen 10. In this embodiment, an overlayer 30 is provided on the opaque layer 16. Overlayer 30 can be substantially optically clear or include a minimal amount of pigment and can include an ablatable material, such as cellulose nitrate lacquer that can contain small amounts of carbon black. In a particular embodiment, overlayer 30 has a thickness of from about 25 micrometers to 100 micrometers and has a refractive index about the same as the opaque layer 16.

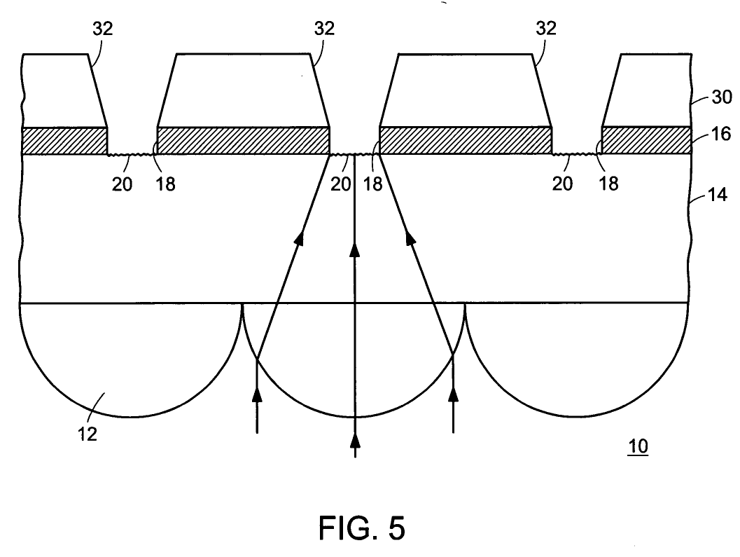

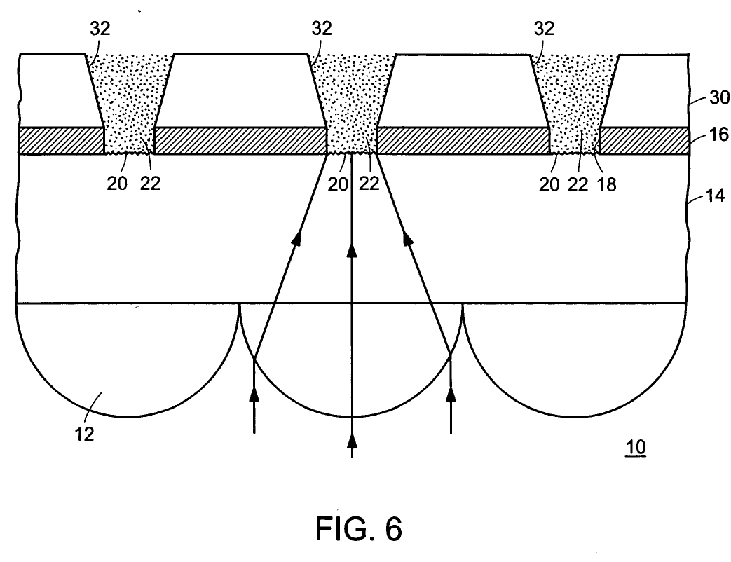

As illustrated in FIG. 5, when the apertures 18 are formed in the opaque layer 16 by the ablative process described above, apertures 32 are formed in overlayer 30. The apertures 32 allow a deep groove or hole to be formed that can be filled with bulk diffuser 22 as illustrated in FIG. 6. The diffuser 22 in apertures 32 further spreads the projected image to the viewer, and further decreases the grain and speckle of the projected image.

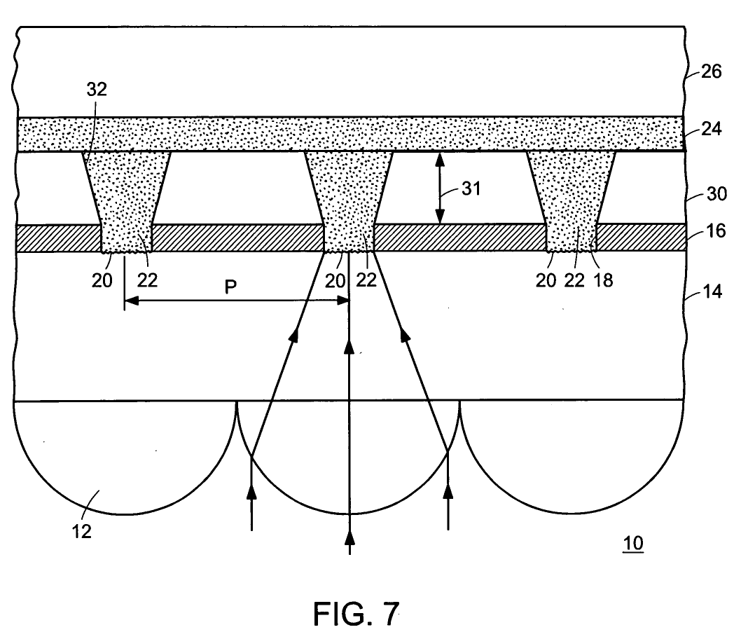

A deep aperture can also be provided by using a thicker opaque layer 16. However, the deeper groove in the opaque layer 16 causes more light “louvering”, which acts to block light that passes through the aperture at angles substantially departed from perpendicular to the rear-projection screen 10. Since overlayer 30 is transparent it reduces the amount of louvering, but still allows for a deeper aperture 32 to be filled with bulk diffuser 22 to reduce grain and speckle. A cover 26 can be attached to the overlayer 30 by an adhesive 24, as illustrated in FIG. 7, to form a rear-projection screen 10. In a particular embodiment, the overlayer 30 has a thickness 31 about one-third of the pitch P of the apertures 18.

An array of lenticular lenses, when irradiated by ablating laser radiation, produces an array of linear apertures as shown in FIG. 5. Alternately, if a two-dimensional array of lenses or microlenses are employed as the focusing elements, they produce a two-dimensional array of apertures, as shown in FIG. 10. In FIG. 10 the apertures 18 formed in the light-absorbing layer 16 are shown to be square, although they can be any other shape, including hexagonal or circular, or of an irregular shape owing to the speckly nature of the coherent laser light used for ablation. The various shaped apertures retain the SRD texture 20 at the bottom resulting from the laser ablation process.

The screen 10 of FIG. 7 has at least three advantages over prior art screens. First, ambient light rejection (ALR) is less than prior art configurations. More particularly, light incident on the cover 26 that does not pass through the apertures 18 impinges on opaque layer 16. Since the refractive index of the opaque layer 16 is about the same as the refractive index of the overlayer 30, substantially all of the light incident on the opaque layer is absorbed. Some bulk diffuser layers of prior art screens are disposed across the entire surface of the screen and have a refractive index different than the opaque layer, which causes some ambient light to be back scattered before it reaches the opaque layer.

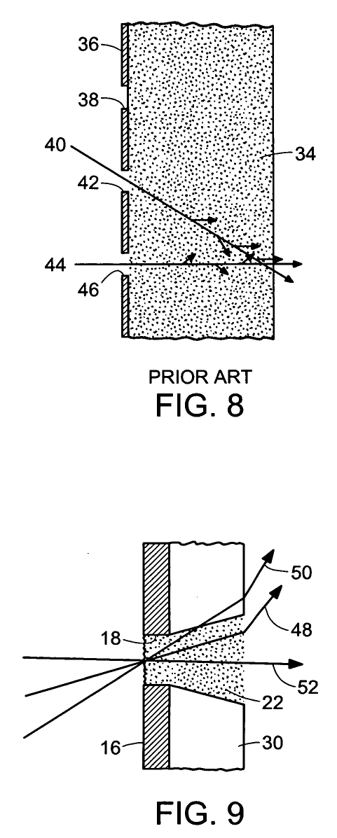

Second, the screen 10 of FIG. 7 has increased resolution over prior art screens. As illustrated in FIG. 8, a prior art screen includes a bulk diffuser 34 disposed over the entire surface of an opaque layer 36 having apertures 38 therethrough. It can be seen that some projected light from one aperture spills over and is diffused by diffuser 34 above an adjacent aperture with a corresponding reduction in spatial resolution. That is, light ray 40 passing through aperture 42 is diffused by diffuser 34 and combines with light ray 44 passing through adjacent aperture 46. The thicker the diffuser 34 is, the worse the resolution of the screen is. In contrast, the diffuser of the present application is thinner and thus substantially eliminates light overlap between adjacent apertures.

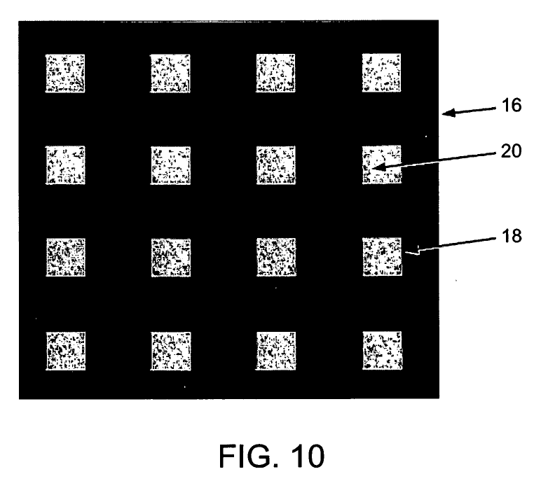

A third advantage of the rear-projection screen 10 of the present application relates to color shift. As present rear-projection screens are viewed at increasingly off-axis, i.e., non-normal, viewing angles, the projected image becomes bluer in appearance. In a particular embodiment, overlayer 30 can include a light-absorbing material therein and/or a light-absorbing material thereon. The light-absorbing material can include a blue or color light-absorbing tint to eliminate or substantially reduce color shift. The light-absorbing material can be equal and opposite to the coloring caused by the bulk diffuser 22. As illustrated in FIG. 9, light ray 48 passing through aperture 18 is blue shifted. Light ray 50 passes through the overlayer 30 and thus is color corrected by the light-absorbing material. Light ray 52 passes through the aperture 18 and is not color shifted.

While this invention has been particularly shown and described with references to various embodiments thereof, it will be understood by those skilled in the art that various changes in form and details may be made therein without departing from the scope of the invention encompassed by the appended claims.

What is claimed is:

1. A rear-projection screen, comprising:
a substrate including a first side and a second side;
lenticulars disposed on the first side of the substrate;
an opaque layer disposed on the second side of the substrate, the opaque layer including a plurality of apertures therethrough; and
a surface relief diffuser provided in the substrate at the plurality of apertures.

2. The rear-projection screen of claim 1, further includes a bulk diffuser at the plurality of apertures.

3. The rear-projection screen of claim 1, further includes a cover attached to the opaque layer.

4. The rear-projection screen of claim 1, wherein the surface relief diffuser is formed by a laser ablation process.

5. The rear-projection screen of claim 1, wherein the apertures are elliptical in shape.

6. The rear-projection screen of claim 1 wherein the apertures are circular in shape.

7. The rear-projection screen of claim 1 wherein the apertures are square in shape.

8. The rear-projection screen of claim 1, wherein said apertures are arranged in a one-dimensional array.

9. The rear-projection screen of claim 1 wherein said opaque layer includes a thickness in the range of between about 10 and 30 micrometers.

10. The rear-projection screen of claim 1, wherein said apertures are arranged in a two-dimensional array.

11. A method for forming a rear-projection screen, comprising:
forming apertures on a first side of a substrate;
forming an opaque layer on a second side of the substrate; and
irradiating the apertures to form a plurality of apertures in the opaque layer and a surface relief diffuser in the substrate at the apertures.

12. The method of claim 11, further includes providing a bulk diffuser in the plurality of apertures.

13. The method of claim 11, further includes attaching a cover to the opaque layer.

14. A rear-projection screen, comprising:
a substrate including a first side and a second side;
lenticulars disposed on the first side of the substrate;
an opaque layer disposed on the second side of the substrate;
an overlayer disposed on the opaque layer, the opaque layer and the overlayer disposed on the opaque layer including a plurality of apertures therethrough; and
a bulk diffuser at the plurality of apertures.

15. The rear-projection screen of claim 14, further includes a surface relief diffuser provided in the substrate at the plurality of apertures.

16. The rear-projection screen of claim 14, further includes a cover attached to the overlayer disposed on the opaque layer.

17. The rear-projection screen of claim 14, wherein the surface relief diffuser and the plurality of apertures are formed by a laser ablation process.

18. The rear-projection screen of claim 14, wherein the apertures are elliptical in shape.

19. The rear-projection screen of claim 14, wherein the apertures are circular in shape.

20. The rear-projection screen of claim 14, wherein said apertures are arranged in a one-dimensional array.

21. The rear-projection screen of claim 14, wherein said apertures are arranged in a two-dimensional array.

22. The rear-projection screen of claim 14, wherein the overlayer disposed on the opaque layer includes a light-absorbing material.

23. The rear-projection screen of claim 22, wherein the light-absorbing material includes a blue light-absorbing tint.

24. The rear-projection screen of claim 14, wherein a refractive index of the opaque layer is about the same as a refractive index of the overlayer disposed on the opaque layer.

25. The rear-projection screen of claim 14, wherein said opaque layer includes a thickness in the range of between about 10 and 30 micrometers.

26. The rear-projection screen of claim 14, wherein said overlayer includes a thickness of the range of between about 25 and 100 micrometers.

27. A method for forming a rear-projection screen, comprising:
forming lenticulars on a first side of a substrate;
forming an opaque layer on a second side of the substrate;
forming an overlayer on the opaque layer; and
irradiating the apertures to form a plurality of apertures in the opaque layer and the overlayer on the opaque layer.

28. The method of claim 27, wherein irradiating the apertures forms a surface relief diffuser in the substrate at the plurality of apertures.

29. The method of claim 27, further includes providing a bulk diffuser in the plurality of apertures.

30. The method of claim 27, further includes attaching a cover to the layer.

31. The method of claim 27, further includes providing a light-absorbing material in and/or on the layer on the opaque layer.

32. The method of claim 31, wherein the light-absorbing material includes a blue light-absorbing tint.

33. The method of claim 27, wherein said apertures are formed in a one-dimensional array.

34. The method of claim 27, wherein said apertures are formed in a two-dimensional array.

35. The method of claim 27, wherein said opaque layer is formed to a thickness in the range of between about 10 and 30 micrometers.

36. The method of claim 27, wherein said overlayer is formed to a thickness in the range of between about 25 and 100 micrometers.

37. A rear-projection screen, comprising:
a substrate including a first side and a second side;
lenticulars disposed on the first side of the substrate;
an opaque layer disposed on the second side of the substrate, the opaque layer including a plurality of apertures therethrough; and
a diffuser provided only within in the plurality of apertures.

38. The rear-projection screen of claim 37, wherein said diffuser is a bulk diffuser.

39. The rear-projection screen of claim 37, wherein said diffuser is a surface relief diffuser.
